(19) United States
(12) Patent Application Publication
(10) Pub. No.: US 2021/0397793 A1
(43) Pub. Date: Dec. 23, 2021

(54) Intelligent Tone Detection and Rewrite

(71) Applicant: MICROSOFT TECHNOLOGY LICENSING, LLC, Redmond, WA (US)

(72) Inventors: Zhang LI, Bellevue, WA (US); Siqing CHEN, Bellevue, WA (US); Tomasz Lukasz RELIGA, Seattle, WA (US); Kaushik Ramaiah NARAYANAN, Bellevue, WA (US); Susan Michele HENDRICH, Kirkland, WA (US); Ruth KIKIN-GIL, Bellevue, WA (US); Sara Correa BELL, Seattle, WA (US); Marian Kimberley CHUA, Bellevue, WA (US); Deqing LI, Kirkland, WA (US)

(73) Assignee: MICROSOFT TECHNOLOGY LICENSING, LLC, Redmond, WA (US)

(21) Appl. No.: 16/904,037

(22) Filed: Jun. 17, 2020

(51) Int. Cl. G06F 40/30; G06F 40/166; G06F 40/205; G06F 3/0481; G06N 20/00

(52) U.S. Cl. CPC G06F 40/30; G06F 40/166; G06N 20/00; G06F 3/0481; G06F 40/205

(57) ABSTRACT

A method and system for providing tone detection and modification for a content segment may include receiving a request to detect a tone for the content segment, inputting the content segment into a first machine-learning (ML) model to detect the tone for the content segment, obtaining the detected tone as a first output from the first ML model, inputting the content segment into a second ML model for modifying the tone from the detected tone to a modified tone, obtaining at least one rephrased content segment as a second output from the second ML model, the rephrased content segment modifying the tone of the content segment from the detected tone to the modified tone, and providing at least one of the detected tone or the at least one rephrased content segment for display to a user.

### TECHNICAL FIELD

This disclosure relates generally to intelligent detection of tone in content, and, more particularly, to a method of and system for intelligently detecting tone in content and/or suggesting replacement segments having a different tone.

### BACKGROUND

Users of computing devices often use various content creation applications to create textual content. For example, users may utilize an application to write an email, prepare an essay, document their work, prepare a presentation and the like. Sometimes while creating content, the user may be unaware of the emotional attitude carried by their content. For example, the user may not realize that one or more sentences in a message they are writing conveys an angry tone. At other times, the user may desire to write a formal message and not notice that some of their content contains informal language.

Furthermore, while some users may notice that the emotional tone carried by their content is inappropriate, they may find it challenging to change the tone. This is because changing the tone may require a detailed examination of the content to first identify inappropriately worded content and then being proficient in changing the language to convey a desired tone. This is often a time consuming and challenging process.

Hence, there is a need for improved systems and methods of intelligent detection and modification of tone.

### SUMMARY

In one general aspect, the instant application describes a data processing system having a processor and a memory in communication with the processor wherein the memory stores executable instructions that, when executed by the processor, cause the data processing system to perform multiple functions. The functions may receiving a request to detect a tone for a content segment, inputting the content segment into a first machine-learning (ML) model to detect the tone for the content segment, obtaining the detected tone as a first output from the first ML model, inputting the content segment into a second ML model for modifying the tone from the detected tone to a modified tone, obtaining at least one rephrased content segment as a second output from the second ML model, the rephrased content segment modifying the tone of the content segment from the detected tone to the modified tone, and providing at least one of the detected tone or the at least one rephrased content segment for display.

In yet another general aspect, the instant application describes a method for providing tone detection for a content segment. The method may include receiving a request to detect a tone for the content segment, inputting the content segment into a first machine-learning (ML) model to detect the tone for the content segment, obtaining the detected tone as a first output from the first ML model, inputting the content segment into a second ML model for modifying the tone from the detected tone to a modified tone, obtaining at least one rephrased content segment as a second output from the second ML model, the rephrased content segment modifying the tone of the content segment from the detected tone to the modified tone, and providing at least one of the detected tone or the at least one rephrased content segment for display.

In a further general aspect, the instant application describes a non-transitory computer readable medium on which are stored instructions that when executed cause a programmable device to receive a request to detect a tone for a content segment, input the content segment into a first machine-learning (ML) model to detect the tone for the content segment, obtain the detected tone as a first output from the first ML model, input the content segment into a second ML model for modifying the tone from the detected tone to a modified tone, obtain at least one rephrased content segment as a second output from the second ML model, the rephrased content segment modifying the tone of the content segment from the detected tone to the modified tone, and provide at least one of the detected tone or the at least one rephrased content segment for display.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1A-1C depict an example system upon which aspects of this disclosure may be implemented.

FIG. 2A-2D are example graphical user interface (GUI) screens for allowing a user to request and receive tone detection for a selected text segment.

FIGS. 3A-3B are example GUI screens for providing tone detection and modification of content without user request.

FIGS. 4A-4C are example GUI screens for allowing the user to choose one or more tones for a document.

FIG. 5 is a flow diagram depicting an example method for providing intelligent tone detection and modification for a selected text segment.

FIG. 6 is a block diagram illustrating an example software architecture, various portions of which may be used in conjunction with various hardware architectures herein described.

FIG. 7 is a block diagram illustrating components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well known methods, procedures, components, and/or circuitry have been described at a relatively high-level, without detail, in order to avoid unnecessarily obscuring aspects of the present teachings.

In today's fast-paced environment, users of computing devices often create many different types of digital content on a given day. These may include email messages, instant messages, presentations, word documents, social media posts and others. Sometimes, there is not enough time to review the content carefully before it is shared with others. This may be particularly the case with email or instant messages. As a result, users may not recognize that the tone of their content is inappropriate. Other times, even though a user has time to review his/her content, they may not realize that the tone conveyed by their content is inappropriate. Moreover, even if the user identifies an undesired or inappropriate tone, it may not be easy to revise the tone. For example, it may not be clear to users how to strike the right balance between expressing their emotions and keeping the tone appropriate. Furthermore, reviewing and rewriting the content may take a lot of time and effort.

Some currently used applications offer computer-based review and/or rephrasing of content. However, these currently used reviewing and rephrasing mechanisms often have the technical problem of being limited to reviewing of grammar and/or typographical errors. Moreover, the currently offered rephrasing mechanisms do not provide an ability to revise the tone of content. Thus, if a user relies on the currently available mechanisms for reviewing and rephrasing their content, they are not likely to detect an improper tone. Furthermore, the available mechanisms are not able to offer any assistance to users on rewriting the content to convey a desired tone.

To address these technical problems and more, in an example, this description provides a technical solution used for intelligently detecting tone of content and providing suggestions for changing the tone from the current tone to a different tone. To do so, techniques may be used to examine content (e.g. written or spoken content), parse the content into one or more segments (e.g., sentences and/or phrases), and examine each of the segments to detect one or more tones. The tone(s) may be detected by utilizing one or more machine-learning (ML) models that are trained to detect specific tones. Once a tone is detected and/or a desired tone is specified, one or more ML models may be utilized to provide suggestions for rewriting the segments to convey a different tone. To achieve this, the segment may be examined along with some or all of the remaining content of the document, context, formatting and/or other characteristics of the document, in addition to user-specific history and information, and/or non-linguistic features. The examined information may be used to provide suggested rephrases for revising the tone of the segment. In one implementation, the suggested rephrases are displayed in a user interface (UI) element alongside the document to enable the user to view and choose from them conveniently. Additionally, techniques may be used to receive feedback from the user and utilize the feedback to improve ML models used to detect tone and/or provide the suggested rephrases. The feedback may be explicit, for example, when a user chooses to report a detected tone as incorrect and/or a suggestion as not relevant and/or inaccurate. Furthermore, feedback may be obtained as part of the process based on user interaction with the detected tone and/or selection of the suggested rephrases. For example, the application may transmit information about which suggestion was selected by a user to a data store to use for ongoing training of the ML model(s). This type of feedback may be anonymized and processed to ensure it is privacy compliant. As a result, the technical solution provides an improved method of reviewing content and identifying improper tone. Furthermore, the technical solution provides rephrase suggestions for revising the tone of content by allowing a user to easily identify inappropriate tone and quickly select intelligently suggested rephrases for modifying the tone.

As will be understood by persons of skill in the art upon reading this disclosure, benefits and advantages provided by such implementations can include, but are not limited to, a technical solution to the technical problems of inefficient, inadequate, and/or inaccurate review and/or rephrase suggestion mechanisms. Technical solutions and implementations provided herein optimize the process of detecting improper tone and providing suggestions for modifying the tone by notifying the user of one or more tones detected in content and by providing easily accessible UI element(s) which contain intelligently suggested rephrases for modifying the improper tone to a desired tone. This may eliminate the need for the user to carefully review content for not only grammar and spelling, but also for tone, and to come up with their own alternative way of rewriting the content to provide a more proper tone. The benefits provided by these technology-based solutions yield more user-friendly applications, improved communications and increased system and user efficiency.

As a general matter, the methods and systems described herein may include, or otherwise make use of, a machine-trained model to identify contents related to a text. Machine learning (ML) generally involves various algorithms that a computer can automatically learn over time. The foundation of these algorithms is generally built on mathematics and statistics that can be employed to predict events, classify entities, diagnose problems, and model function approximations. As an example, a system can be trained using data generated by a ML model in order to identify patterns in user activity and/or determine associations between various words and emotional tone. Such determination may be made following the accumulation, review, and/or analysis of data from a large number of users over time, that may be configured to provide the ML algorithm (MLA) with an initial or ongoing training set. In addition, in some implementations, a user device can be configured to transmit data captured locally during use of relevant application(s) to the cloud or the local ML program and provide supplemental training data that can serve to fine-tune or increase the effectiveness of the MLA. The supplemental data can also be used to facilitate detection of tone and/or to increase the training set for future application versions or updates to the current application.

In different implementations, a training system may be used that includes an initial ML model (which may be referred to as an “ML model trainer”) configured to generate a subsequent trained ML model from training data obtained from a training data repository or from device-generated data. The generation of these ML models may be referred to as “training” or “learning.” The training system may include and/or have access to substantial computation resources for training, such as a cloud, including many computer server systems adapted for machine learning training. In some implementations, the ML model trainer is configured to automatically generate multiple different ML models from the same or similar training data for comparison. For example, different underlying ML algorithms may be trained, such as, but not limited to, decision trees, random decision forests, neural networks, deep learning (for example, convolutional neural networks), support vector machines, regression (for example, support vector regression, Bayesian linear regression, or Gaussian process regression). As another example, size or complexity of a model may be varied between different ML models, such as a maximum depth for decision trees, or a number and/or size of hidden layers in a convolutional neural network. As another example, different training approaches may be used for training different ML models, such as, but not limited to, selection of training, validation, and test sets of training data, ordering and/or weighting of training data items, or numbers of training iterations. One or more of the resulting multiple trained ML models may be selected based on factors such as, but not limited to, accuracy, computational efficiency, and/or power efficiency. In some implementations, a single trained ML model may be produced.

The training data may be continually updated, and one or more of the models used by the system can be revised or regenerated to reflect the updates to the training data. Over time, the training system (whether stored remotely, locally, or both) can be configured to receive and accumulate more and more training data items, thereby increasing the amount and variety of training data available for ML model training, resulting in increased accuracy, effectiveness, and robustness of trained ML models.

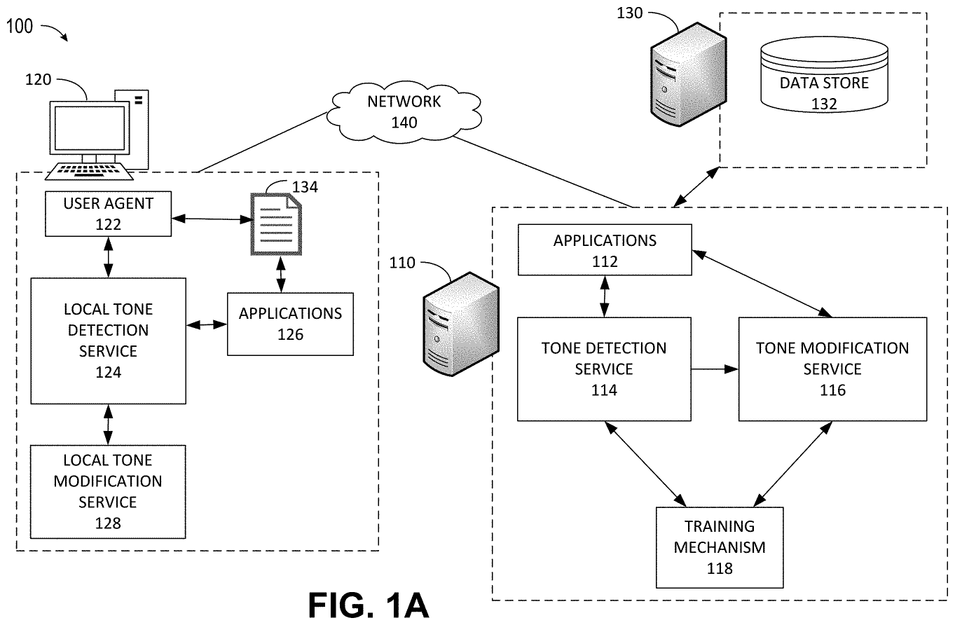

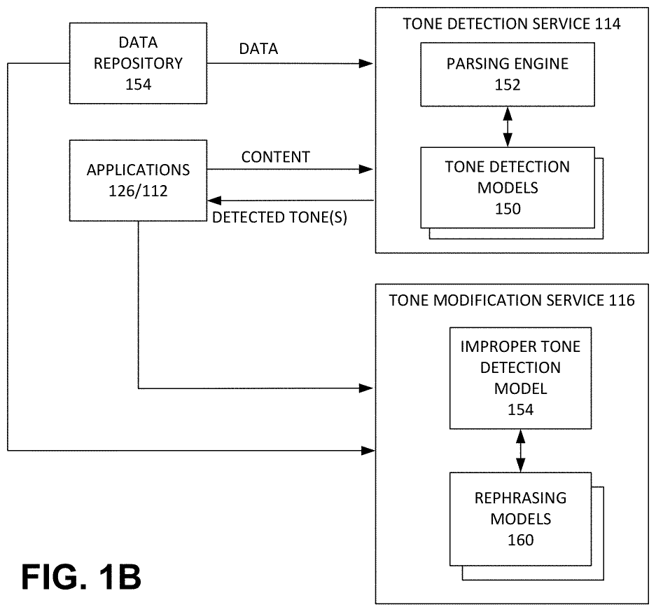

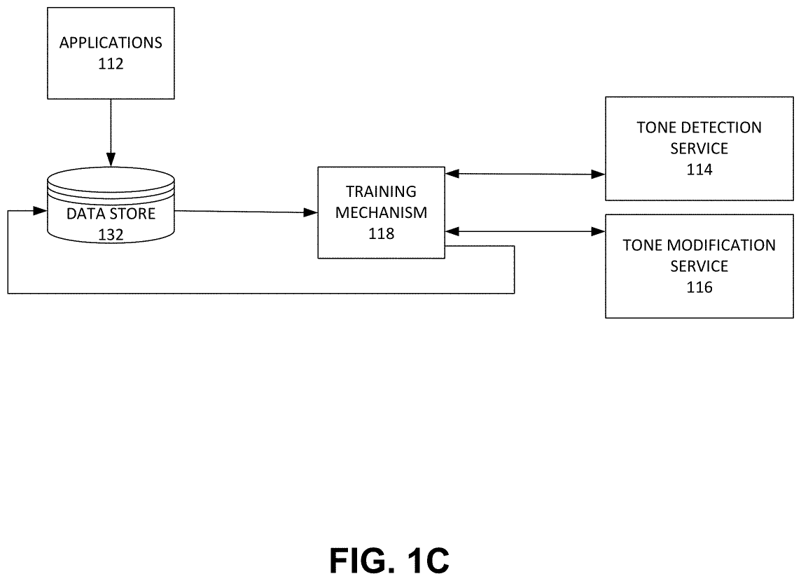

FIG. 1A illustrates an example system 100, upon which aspects of this disclosure may be implemented. The system 100 may include a sever 110 which may include and/or execute a tone detection service 114 and a tone modification service 116. The server 110 may operate as a shared resource server located at an enterprise accessible by various computer client devices such as client device 120. The server may also operate as a cloud-based server for offering global tone detection and modification services. Although shown as one server, the server 110 may represent multiple servers for performing various different operations. For example, the server 110 may include one or more processing servers for performing the operations of the tone detection service 114 and the tone modification service 116.

The detection service 114 may provide intelligent tone detection within an enterprise and/or globally for a group of users. The tone detection service 114 may operate to examine content, parse the content into one or more segments when needed, and to identify one or more tones conveyed by the segment. Tone as used in this disclosure may refer to the attitude (e.g., emotional attitude) of the content creator that is conveyed by written or spoken content. For example, identified tones may include formal, informal, angry, accusatory, disapproving, encouraging, optimistic, forceful, neutral, egocentric, concerned, excited, worried, regretful, unassuming, curious, sad, and/or surprised. The tone detection service may be provided by one or more tone detection ML models, as further discussed below with regards to FIG. 1B.

The tone modification service 116 may provide intelligent replacement segment suggestions that modify the tone of the original segment. The tone modification service 116 may be provided within an enterprise and/or globally for a group of users. The tone modification service 116 may operate to receive one or more detected and/or desired tones for a segment, examine the segment, examine the remining content of the document and/or examine context and non-linguistic features of the document to intelligently suggest one or more replacement segment options that change the tone of the segment from the detected tone to a different tone. The tone modification service may be provided by one or more rephasing ML models, as further discussed below with regards to FIG. 1B.

The server 110 may be connected to or include a storage server 130 containing a data store 132. The data store 132 may function as a repository in which documents and/or data sets (e.g., training data sets) may be stored. One or more ML models used by the tone detection service 114 and/or the tone modification service 116 may be trained by a training mechanism 118. The training mechanism 118 may use training data sets stored in the data store 132 to provide initial and ongoing training for each of the models. Alternatively or additionally, the training mechanism 118 may use training data sets unrelated to the data store. This may include training data such as knowledge from public repositories (e.g., Internet), knowledge from other enterprise sources, or knowledge from other pretrained mechanisms (e.g., pretrained models). In one implementation, the training mechanism 118 may use labeled training data from the data store 132 to train one or more of the ML models via deep neural network(s) or other types of ML algorithms. Alternatively or additionally, the training mechanism 118 may use unlabeled training data. The initial training may be performed in an offline stage or may be performed online. Additionally and/or alternatively, the one or more ML models may be trained using batch learning.

It should be noted that the ML model(s) detecting one or more tones and/or providing tone modification services may be hosted locally on the client device 120 or remotely, e.g., in the cloud. In one implementation, some ML models are hosted locally, while others are stored remotely. This may enable the client device 120 to provide some tone detection and modification even when the client device 120 is not connected to a network.

The server 110 may also include or be connected to one or more online applications 112 that allow a user to interactively view, generate and/or edit digital content. Examples of suitable applications include, but are not limited to a word processing application, a presentation application, a note taking application, a text editing application, an email application, an instant messaging application, a communications application, a web-browsing application, a collaboration application, and a desktop publishing application.

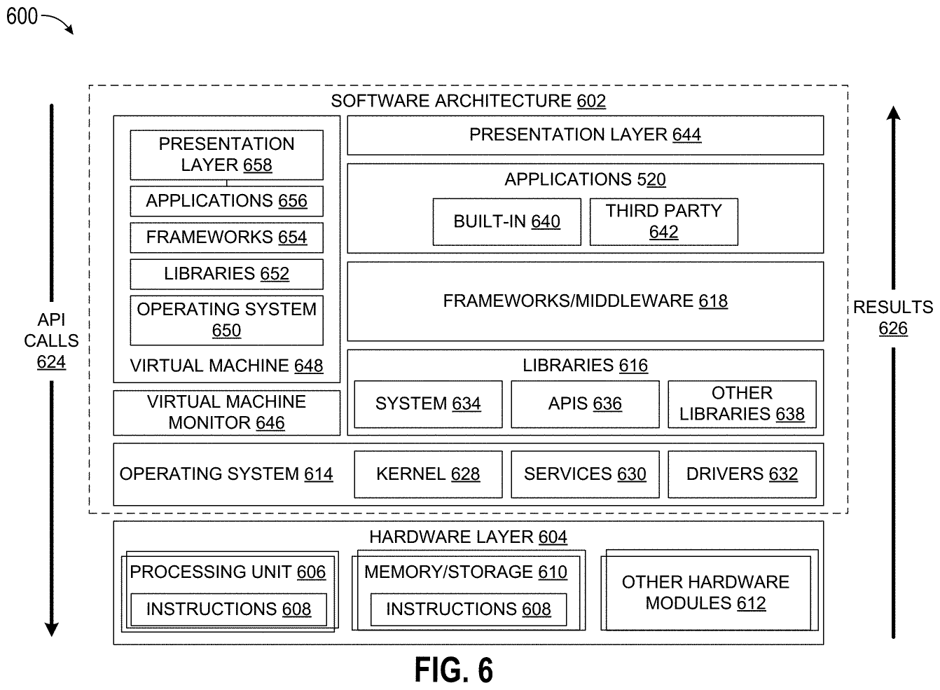

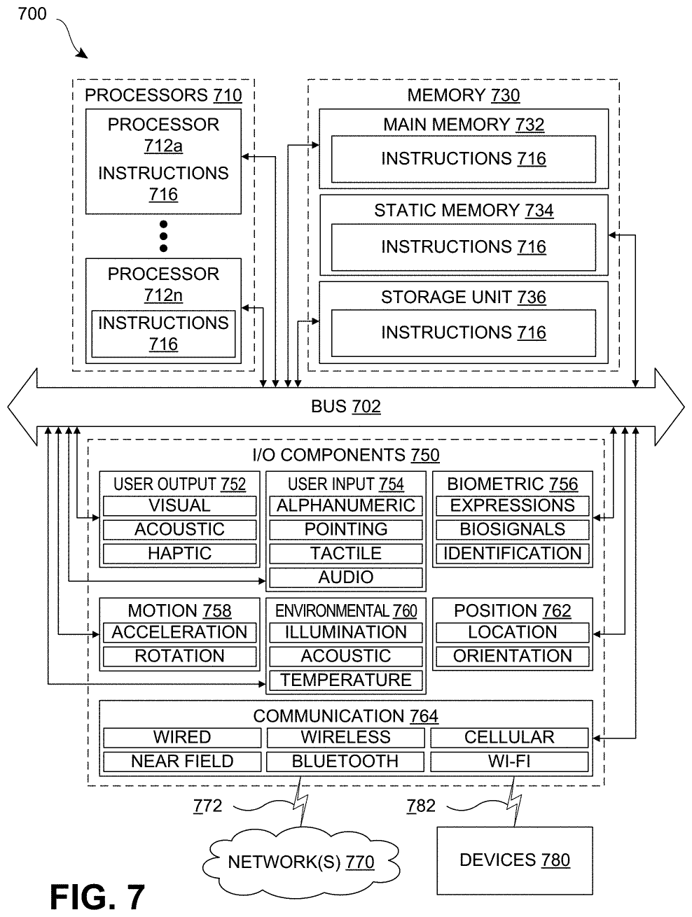

The client device 120 may be connected to the server 110 via a network 140. The network 140 may be a wired or wireless network(s) or a combination of wired and wireless networks that connect one or more elements of the system 100. The client device 120 may be a personal or handheld computing device having or being connected to input/output elements that enable a user to interact with digital content such as content of an electronic document 134 on the client device 120. Examples of suitable client devices 120 include but are not limited to personal computers, desktop computers, laptop computers, mobile telephones; smart phones; tablets; phablets; smart watches; wearable computers; gaming devices/computers; televisions; head-mounted display devices and the like. The internal hardware structure of a client device is discussed in greater detail in regard to FIGS. 6 and 7.

The client device 120 may include one or more applications 126. Each application 126 may be a computer program executed on the client device that configures the device to be responsive to user input to allow a user to interactively view, generate and/or edit digital content such as content within the electronic document 134. The electronic document 134 can include any type of data, such as text (e.g., alphabets, numbers, symbols), emoticons, still images, video and audio. The electronic document 134 and the term document used herein can be representative of any file that can be created via an application executing on a computer device. Examples of documents include but are not limited to word-processing documents, presentations, spreadsheets, notebooks, email messages, websites (e.g., SharePoint sites), media files and the like. The electronic document 134 may be stored locally on the client device 120, stored in the data store 132 or stored in a different data store and/or server.

The application 126 may process the electronic document 134, in response to user input through an input device, to create and/or modify the content of the electronic document 134, by displaying or otherwise presenting display data, such as a GUI which includes the content of the electronic document 134 to the user. Examples of suitable applications include, but are not limited to a word processing application, a presentation application, a note taking application, a text editing application, an email application, an instant messaging application, a communications application, a web-browsing application, a collaboration application and a desktop publishing application.

The client device 120 may also access applications 112 that are run on the server 110 and provided via an online service as described above. In one implementation, applications 112 may communicate via the network 140 with a user agent 122, such as a browser, executing on the client device 120. The user agent 122 may provide a UI that allows the user to interact with application content and electronic documents stored in the data store 132. The UI may be displayed on a display device of the client device 120 by utilizing for example the user agent 122. In some examples, the user agent 122 may be a dedicated client application that provides a UI and access to electronic documents stored in the data store 132. In other examples, applications used to create, modify and/or view digital content such as content of electronic documents maybe local applications such as the applications 126 that are stored and executed on the client device 120, and provide a UI that allows the user to interact with application content and electronic document 134. In some implementations, the user agent 122 may include a browser plugin that provides access to tone detection and modification services for content created via the user agent (e.g., content created on the web such as social media posts and the like).

In one implementation, the client device 120 may also include a local tone detection service 124 for providing some intelligent tone detection of content, for example, content in documents, such as the document 134, and a local tone modification service 128 for performing local intelligent tone modification. In an example, the local tone detection 124 and local tone modification service 128 may operate with the applications 126 to provide local tone detection and modification services. For example, when the client device 120 is offline, the local tone detection and/or modification services may make use of one or more local repositories to detect tone and/or provide suggestions for modifying tone. In one implementation, enterprise-based repositories that are cached locally may also be used to provide local tone detection and/or modification.

It should be noted that each of the tone detection service 114, tone modification service 116, local tone detection service 124 and local tone modification service 128 may be implemented as software, hardware, or combinations thereof.

FIG. 1B depicts a system level data flow between some of the elements of system 100. As discussed above, content being viewed, edited or created by one or more applications 126 and/or online applications 112 may be transmitted to the tone detection service 114 to identify one or more tones associated with one or more segments of the content. In some implementations, content transmitted to the tone detection service 114 may include those created via the user agent 122 (shown in FIG. 1A). For example, the content may originate from a website the enables the user to write a post. In such instances, the content may be transmitted from the user agent 122 to the tone detection service 114. The content may be transmitted upon a user request. For example, when the user utilizes an input/output device (e.g. a mouse) coupled to the client device 120 to invoke a UI option requesting tone detection for a selected content segment, the selected content segment may be transmitted along with the request for tone detection. Alternatively, the content may be transmitted without direct user request in some applications (e.g., email applications or instant messaging applications) to enable automatic notification of improper tone. For example, some applications may automatically submit a request for tone detection when a user begins creating content (e.g., when the user finishes writing a sentence).

In addition to the content, the request for tone detection may include other information that can be used to detect the tone. This may include information about the application used for content creation, contextual information about the document from which the content originates, information about the user creating the content and/or other relevant information. For example, information about the type of document (e.g., word document, email, presentation document, etc.), the topic of the document, the position of the user within an organization (e.g., the user's job title or department to which the user belongs, if known), other non-linguistic features such as the person to whom the document is directed, and the like may be transmitted with the tone detection request. In some implementations, some of the information transmitted with the request may be transmitted from a data repository 154. The data repository may contain user-specific data about the user. For example, it may contain user profile data (e.g., the user's job title, various profiles within which the user creates content such as work profile, blogger profile, social media profile and the like) and/or user history data (e.g., the user's writing style, preferred tone, and the like). The data contained in the data repository 154 may be provided as an input directly from the data repository 154 or it may be retrieved by applications 126 and/or online applications 112 and transmitted from them.

The content transmitted for tone detection may include one or more segments. For example, the content may include multiple sentences (e.g., a paragraph or an entire document). When the transmitted content includes more than one sentence, the tone detection service 114 may utilize a parsing engine 152 to parse the content into one or more smaller segments. In some implementations, this involves parsing the content into individual sentences, where each sentence constitutes one segment for tone detection. If the content does not include individual sentences (e.g., it includes one or more phrases that are not sentences), the content may be parsed into separate segments. For example, the content may be examined to determine if more than one phrase is included within the content and if so to parse the content into the individual phrases. The parsing engine may include one or more classifiers used to classify content into sentences and/or phrases. Thus, the parsing engine may receive the content as an input and may provide the parsed segments as an output.

The parsed segments may be transmitted to a plurality of tone detection models 150 for determining if each segment conveys a specific tone. This may be achieved by utilizing a plurality of trained tone detection models 150. Each tone detection model may be an ML trained for detecting a specific tone. For example, there may be a tone detection model for detecting informal tones, while there is another tone detection model for detecting impolite tones. In some implementations, each tone detection model may include one or more classifiers that classify the segment as either being associated or not associated with a specific tone. In some implementations, the classifier may provide a score identifying the level of association of each segment with the tone. If the score meets a threshold requirement, the tone detection model may determine that the segment conveys the tone. When the score does not meet the threshold requirement, the model may determine that the segment does not convey the tone. Thus, each tone detection model 150 may receive as an input the parsed segments and/or the data related to the user, application, document and the like, and may provide as an output a determination of whether the segment conveys a specific tone.

In some implementations, the score may be used to determine an overall tone for the content (e.g., for multiple sentences, a paragraph or a document). For example, the score may be utilized as a parameter used in a weighted sum of the segments (e.g., each segment is given a weight multiplied by its determined score to calculate the weighted sum for the content). In such a scenario, in addition to the determination of whether the segment conveys a specific tone, each tone detection model 150 may also provide the score. The tone detection service 114 may then calculate the overall tone.

Because there may be multiple tone detection models 150 that detect different tones, each segment may be identified as having multiple tones. For example, a segment may be identified as being both angry and informal, while a different segment is identified as being both sad and angry. Once the detected tone(s) are identified, the detected tone(s) and if identified, the overall tone of the document may be transmitted back as an output to the applications 126/112, where they are used to provide display data to the user to notify the user of the detected tones.

In some implementations, in addition to the detected tones, suggested rephrases that modify the tone from an improper tone to a more proper may also be provided. To achieve this, the tone detection service 114 may transmit the detected tone(s) to the tone modification service 140. The tone modification service may include an improper tone detection model 154 for determining if any of the detected tones are improper. In some implementations, the tone detection model 154 may include a classifier that classifies certain tones as improper. For example, angry, accusatory, and disapproving tones may automatically be flagged as improper tones.

Alternatively, the improper tone detection model 154 may take into account additional information in determining whether a detected tone is improper. This may involve receiving data such as information about the type of content for which tone was detected (e.g., email, instant message, word document), the topic of the document, the position of the user within an organization (e.g., the user's job title or department to which the user belongs, if known), the user profile being used, the person to which the content is directed (e.g., the to line of the email is to the user's manager), the type of application from which the content originates and the like. This data may be received from the data repository 154 and/or applications 126/112 and may be used to determine if the detected tone(s) are improper within the context of the content being generated. This is because, while certain tones may be proper in certain situations, they may not be proper for others. For example, an email written for a close friend may convey an information tone, while an email being written for a client may need to convey a formal tone. By utilizing an improper tone detection model 154 that takes into account contextual information related to the user, content, document, and the like, the tone modification service 116 may determine when to notify the user of an improper tone. It should be noted that while the improper tone detection model 154 is shown as being part of the tone modification service 116, it may be included as part of the tone detection service 114 or may function as a separate service. When included as part of the tone detection service, along with the detected tone(s), the tone detection service 114 may also provide an indication for each detected tone on whether the detected tone is an inappropriate tone. Thus, the improper tone detection model 154 may receive as an input the detected tone(s) along with additional data relating to the user, document and the like and provide as an output a determination of a detected improper tone. The output may be provided back to the applications 126/112 for display to the user.

In addition to the improper tone detection model 154, the tone modification service 116 may include one or more rephrasing models 160. Each rephrasing model 160 may include one or more ML models that enable rephrasing the segment to modify the tone to a desired tone. For example, the rephrasing models 160 may include one rephrasing model for rephrasing the segment in a manner that modifies the tone of the segment from informal to formal. Another rephrasing model may rephrase the segment from angry to neutral. Yet another rephrasing model may rephrase the segment from impolite to polite. In some implementations, each rephrasing model may be for modifying the segment to convey a desired tone regardless of its detected current tone(s). For example, one model may be used to rephrases all segments having a variety of tones to conveying a formal tone. Another model may be used to rephrase all segments such that they convey a neutral tone, and the like. Thus, rephrasing models may provide one or more suggested rephrases that modify a segment to convey a desired tone (e.g. polite, neutral, formal, etc.).

To achieve this, each rephrasing model may take into account parameters relating to the user, user history data (user's usual writing style), the type of content, the type of document, the type of application, and provide suggested rephrases that modify the tone to a desired tone while taking into account the content, context and user preferences. As a result, each rephasing model may receive as an input a segment having an identified tone as well as additional data and provide as an output one or more suggested rephrases for the segment that modify, where the rephrases convey a desired tone. The suggested rephrases may be transmitted to the applications 126/112 for display to the user.

In some implementations, the desired tone is requested by the user. For example, the user may utilize a UI element of the applications 126/112 to set the desired tone of the content to a specific tone (e.g., a menu option is used to set the tone of the document to neutral). In another example, the user may utilize a UI element to request that specific detected tones be converted to specific desired tones (e.g., modify impolite tones to polite tones). The desired tone may be transmitted from the applications 112/126 to the tone modification service 116, where the desired tone may be used to identify which rephrasing model 160 to use for providing rephrasing suggestions.

In alternative implementations, the desired tone is predetermined. For example, there may be one or more predetermined desired tones for each improper tone (e.g., angry to neutral, impolite to polite, informal to formal). Once the improper tone detection 154 identifies an improper tone, the tone modification service 116 may identify a corresponding desired tone for the improper tone and send a request to the rephrasing model for the desired tone to provide suggested rephrases.

It should be noted a that the local tone detection service 124 of the client device 120 (in FIG. 1A) may include similar elements and may function similarly as the tone detection service 114 (as depicted in FIG. 1B). Furthermore, the local tone modification service 128 of the client device 120 (in FIG. 1A) may include similar elements and may function similarly as the tone modification service 116 (as depicted in FIG. 1B).

FIG. 1C depicts how one or more ML models used by the tone detection service 114 and the tone modification service 116 may be trained by using the training mechanism 118. The training mechanism 118 may use training data sets stored in the data store 132 to provide initial and ongoing training for each of the models included in the tone detection service 114 and the tone modification service 116. For example, each of the tone detection models 150, improper tone detection model 154 and each of the rephrasing models 160 may be trained by the training mechanism 118 using corresponding data sets from the data store 132.

The tone detection models 150 may be trained by first identifying a number of tones for which models should be trained. These tones may include formal, informal, angry, accusatory, disapproving, encouraging, optimistic, forceful, neutral, egocentric, concerned, excited, worried, regretful, unassuming, curious, sad, and/or surprised. Then, a large number of segments (e.g., sentences) may be collected. These may be collected from user data or from public sources such as the Internet. Each of the segments in the collected data may be then labeled as conveying one or more tones. The labeling process may be performed by a number of users. The labeled data may then be parsed to create individual groups of segments that relate to each tone. The individual groups of segments may then be used in a supervised learning process to train each of the tone detection models.

The improper tone detection model 154 may be similarly trained using a supervised learning process by using labeled data. The rephrasing models 160, on the other hand, may be trained using one or more pretrained models such as GP, UniLM and others for natural language processing (NPL). The pretrained models may be used to train each rephrasing model 160 to rewrite a segment in a manner that conveys a specific tone (e.g., polite, formal, etc.).

To provide ongoing training, the training mechanism 118 may also use training data sets received from each of the trained ML models (models included in the tone detection service 114 and the tone modification service 116). Furthermore, data may be provided from the training mechanism 118 to the data store 132 to update one or more of the training data sets in order to provide updated and ongoing training. Additionally, the training mechanism 118 may receive training data such as knowledge from public repositories (e.g., Internet), knowledge from other enterprise sources, or knowledge from other pre-trained mechanisms.

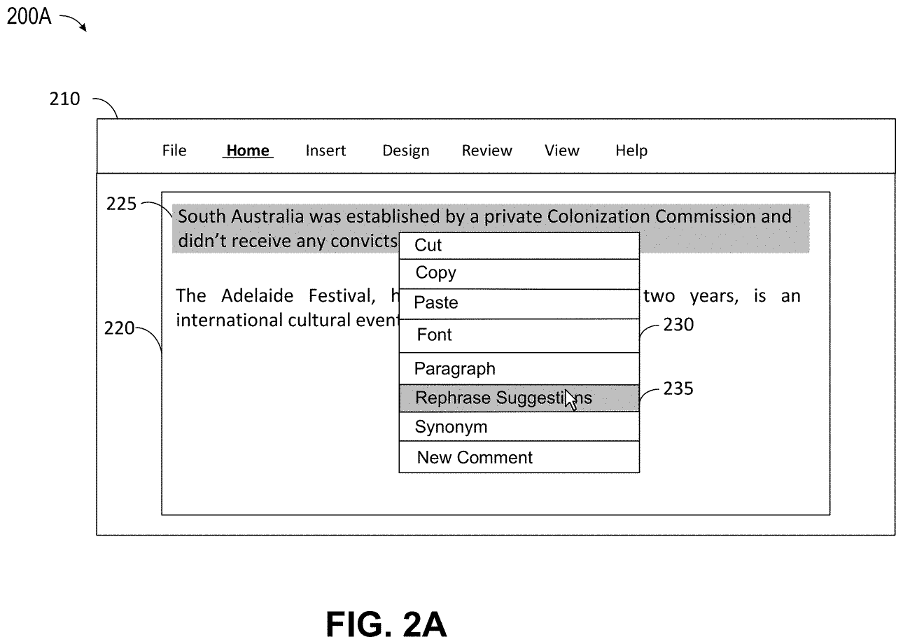

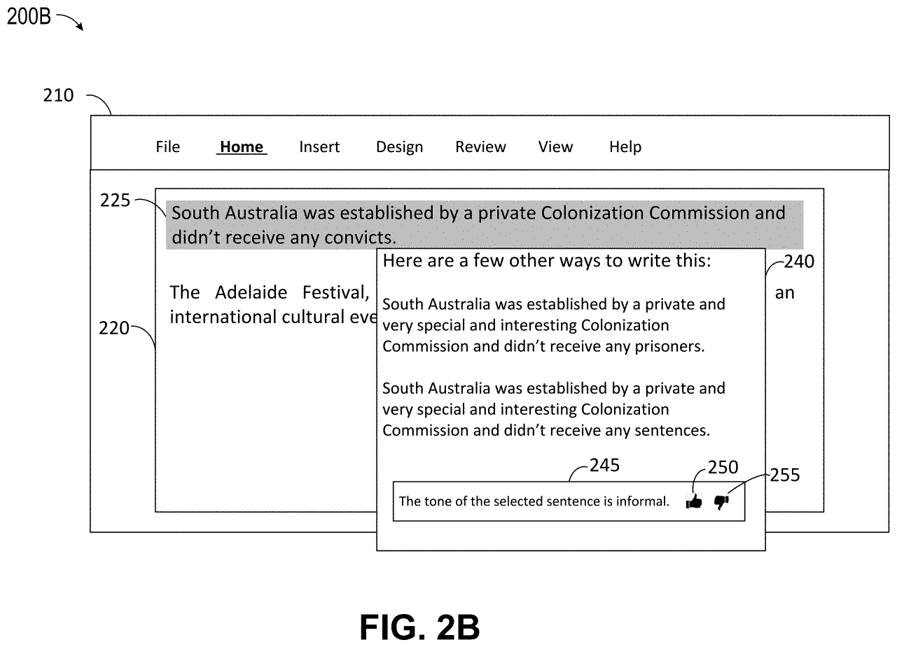

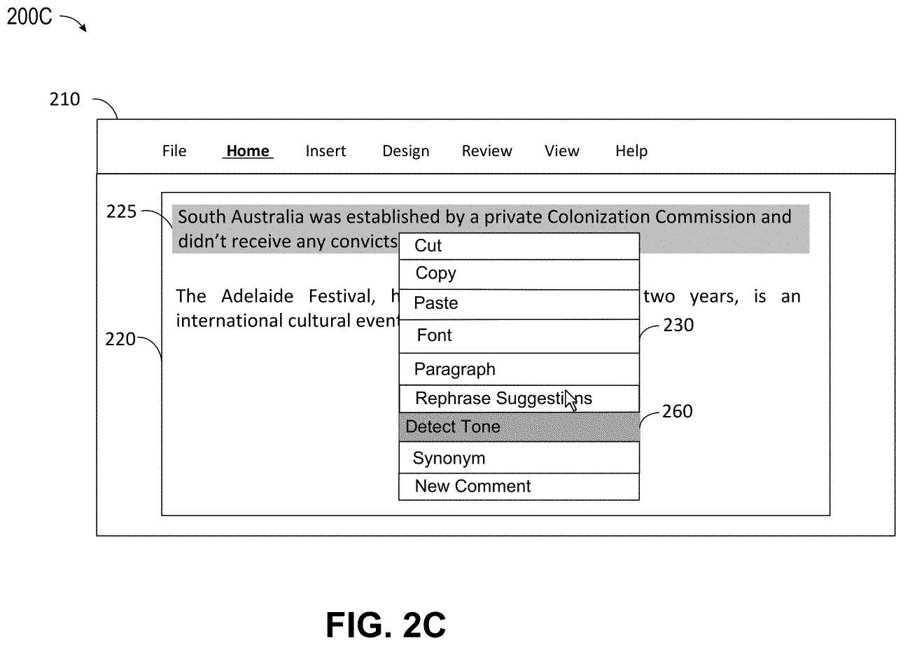

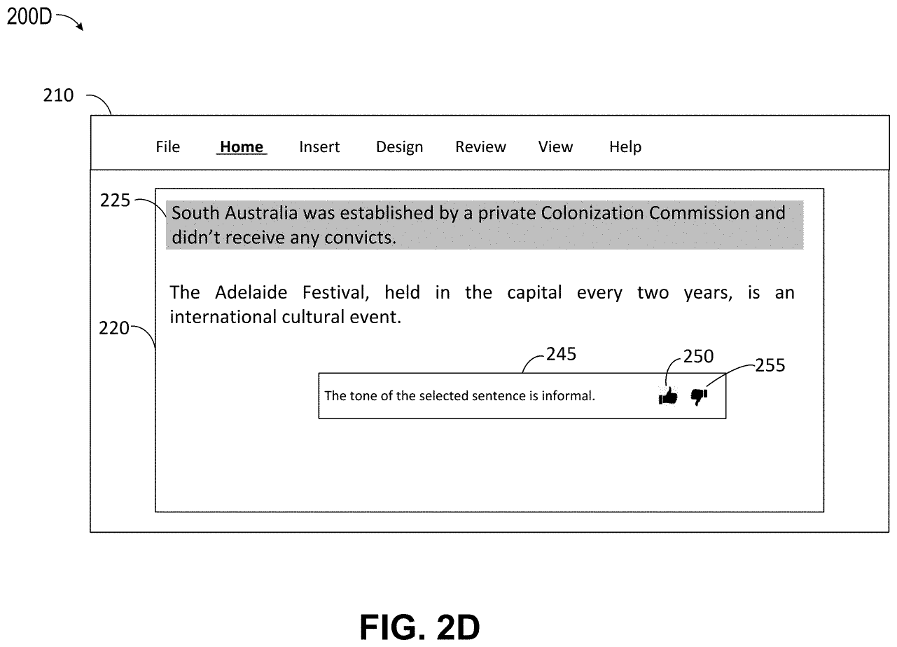

FIG. 2A-2D are example GUI screens for allowing a user to request and receive tone detection for a selected text segment. FIG. 2A is an example GUI screen 200A of a word processing application (e.g., Microsoft Word®) displaying an example document. GUI screen 200A may include a toolbar menu 210 containing various tabs each of which may provide multiple UI elements for performing various tasks. For example, the toolbar menu 210 may provide options for the user to perform one or more tasks to create or edit the document. Screen 200A may also contain a content pane 220 for displaying the content of the document. The content may be displayed to the user for viewing and/or editing purposes and may be created by the user. For example, the user may utilize an input device (e.g., a keyboard) to insert input such as text into the contents pane 220.

As the user creates or edits the contents of the content pane 220, a UI element may be provided for transmitting a request to receive suggestions for replacing a selected text segment of the content with an alternative text segment. A selected text segment can be any portion of the contents of the document and may include one or more words, sentences or paragraphs. The textual contents may include any type of alphanumerical text (e.g., words and numbers in one or more languages). The text segment may also include a text having no content and thus having zero length. In one implementation, a text segment may also include known symbols, emoticons, gifs, animations, and the like. The UI element may be any menu option that can be used to indicate a request by the user. In one implementation, the UI element is provided via the context menu 230. When the user utilizes an input/output device such as a mouse to select a portion of the content such as the portion 225, certain user inputs (e.g., right clicking the mouse) may result in the display of the context menu 230. It should be noted that this is only an example method of initiating the display of UI element for invoking rephrase suggestions. Many other methods of selecting a portion of the contents pane and initiating the display of a UI element for invoking rephrase suggestions are possible. For example, a menu option may be provided as part of the toolbar 210 for invoking rephrase suggestions for selected text segments.

Along with a variety of different options for editing the document, the context menu 230 may provide a menu option 235 for invoking the display of rephrase suggestions for the selected text segment 225. Once menu option 235 is selected, a rephrase pane 240, such as the one displayed in FIG. 2B, may be displayed alongside the contents pane 220 to provide suggested rephrases for the selected text segment. In some implementations, along with the suggested rephrases, the rephrase pane 240 may include a UI element 245 for displaying a detected tone for the selected text segment. The UI element 245 may identify one or more detected tones for the selected text segment. Furthermore, the UI element 245 may include one or more UI elements 250 and 255 for receiving user feedback regarding the detected tones. For example, the UI element 250 may be used to provide positive feedback indicating that the detected tone is accurate, while the UI element 255 may be used to provide negative feedback indicating that the detected tone is inaccurate. Although shown as a separate pane 240 in screen 200B, it should be noted that other UI configurations may be utilized to display the suggested phrases and/or detected tones.

In another example, tone detection may be invoked from a separate menu option such as the menu option 260 displayed in screen 200C of FIG. 1C. The menu option 260 may be provided as part of the context menu 230 and may offer a direct mechanism for requesting tone detection without rephrase suggestions. Thus, once the user selects a text segment such as a sentence and invokes display of the context menu 230, they can request that the tone of the suggested segment be detected. Upon selection of the menu option 260, the application may run a local tone detection service or may send a request to a cloud-based tone detection service to provide a list of identified tones for the selected segment. In response, the application may receive a list of one or more detected tones which may be displayed in a UI element such as the UI element 245 displayed in screen 200D of FIG. 2D. As discussed above, the UI element 245 may include one or more UI elements 250 and 255 for receiving user feedback regarding the detected tones. The received user feedback may be collected and used to provide ongoing training for the ML models used in detecting tone. Many other UI configurations for enabling the user to provide feedback for the detected tones are contemplated. For example, various menu options may be provided for each detected tone or the entirety of detected tones to enable the user to provide feedback.

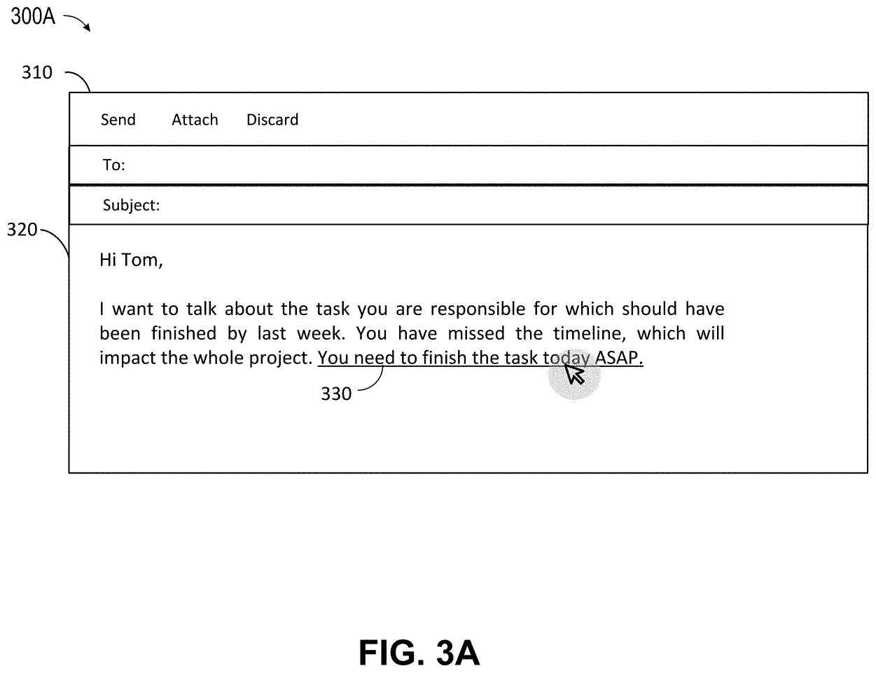

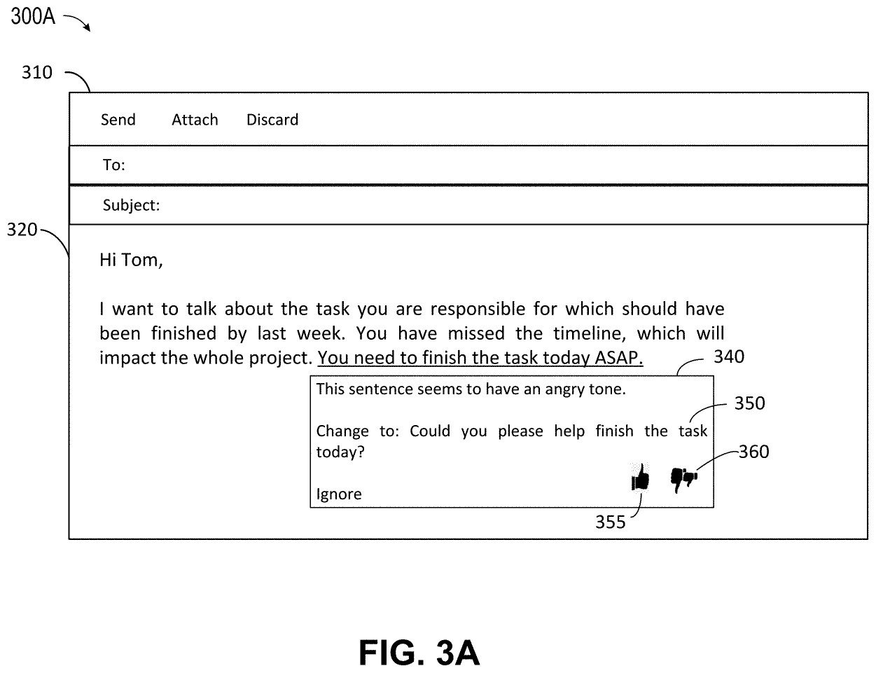

In addition to enabling the user to request tone detection, in some implementation, tone of certain content may be detected automatically (e.g., in the background) and once an improper tone is detected, the user may be notified even if the user has not initiated a request for tone detection. FIGS. 3A-3B are example GUI screens for providing tone detection and modification of content without user request. Screen 300A of FIG. 3A depicts a UI element 310 of a communication application such as an email application. The UI element includes a content pane 320 of a draft email message being created. In some implementations, for content such as email messages, instant messages, web postings and the like, where the content the user is creating relates to communications with one or more other individuals, the content creation application and/or web browser plugin may function to automatically perform tone detection. This may be done to warn the user of tone that may be disrespectful or otherwise improper when the user is communicating with others. In some implementations, automatic tone detection may be done by first determining when a text segment is complete (e.g., when a sentence is complete) and then submitting the completed text segment for tone detection upon its completion. Alternatively and/or additionally, automatic tone detection may be performed once a determination is made that content creation is complete (e.g., the user's name at the end of the email message).

Once a text segment is submitted for text detection, a tone detection service (e.g., the local tone detection service 124 or tone detection service 114 of FIGS. 1A-1C) may be utilized to detect the tone of the text segment(s) and an improper tone detection model may be utilized to determine if any of the detected tones are improper. As discussed above, this may involve taking the remaining content, context, user history, user profile, user's relationship with the recipient and the like into account to determine if the detect tone(s) are improper for the content being created by the user. In some implementations, improper tones for email or instant message communications may include impolite, angry, accusatory, egocentric and/or informal.

When an improper tone for a text segment within the content is detected, one or more notification mechanisms may be employed to notify the user of the improper tone. For example, as depicted in the content pane 320, the segment 330 having an improper tone may be underlined with a highlighted circle positioned over the text segment 330. Alternatively, the text segment may be highlighted. In some implementations, a pop-up menu option containing the text segment having the improper tone is displayed. When the text segment is underlined or highlighted, hovering over the text segment and/or clicking on the text segment may result in displaying a UI element such as the UI element 340 displayed in screen 300B of FIG. 3B. The UI element 340 may be a pop-up menu option that includes an indication of the identified improper tone.

Additionally, the UI element 340 may contain one or more suggested rephrases such as the suggested rephrase 350 for modifying the tone from the improper tone to a more proper tone for the content being created. In some implementations, the more proper tone may be identified automatically, for example by examining the type of content, the recipient's relationship with the user, the user's profile and/or user history data. The examined data may be used to identify the proper tone that should be conveyed by the content. For example, it may be determined based on the content of the email message that the email is a work-related email being sent to the user's direct report and as such should include a polite and/or neutral tone. As such, the segment may be transmitted to a polite and/or neutral tone rephrasing model to rephrase the segment accordingly. In some implementations, clicking on the suggested rephrase 350 may result in the automatic replacement of the text segment 330 with the suggested rephrase 350.

The UI element 340 may also include one or more UI elements such as UI elements 355 and 360 for receive user feedback regarding the detected tone and/or suggested rephrase. Furthermore, the UI element 340 may include an option (e.g., ignore link) for choosing to ignore the detected tone and/or suggested rephrase. In some implementations, when a user chooses to ignore a detected tone and/or suggested rephrase, information regarding the detected tone and/or suggested rephrase may be collected as user feedback to be used in finetuning the trained models.

In implementations where the tone detection occurs upon completion of the content (e.g., upon completion of the email message), in addition and/or alternative to displaying notifications for improper tones, a notification may be provided for the overall tone of the document. For example, a UI element may be displayed that indicates the overall tone of the content is informal. In some implementations, if there are anomalies with the overall tone, a notification may also be provided of such anomalies. For example, an indication may be made of the number of anomalies made and/or they may be identified within the content.

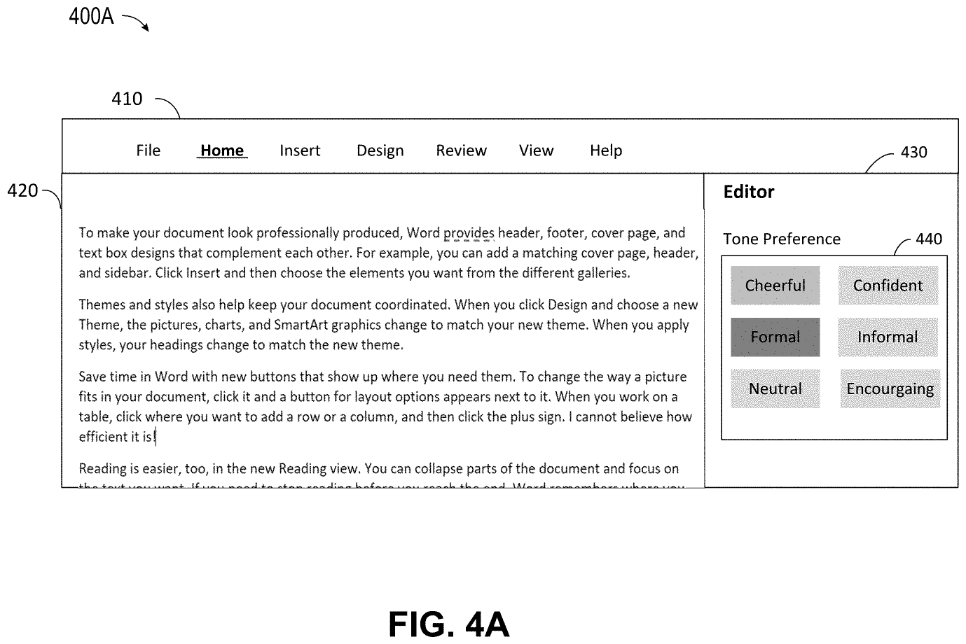

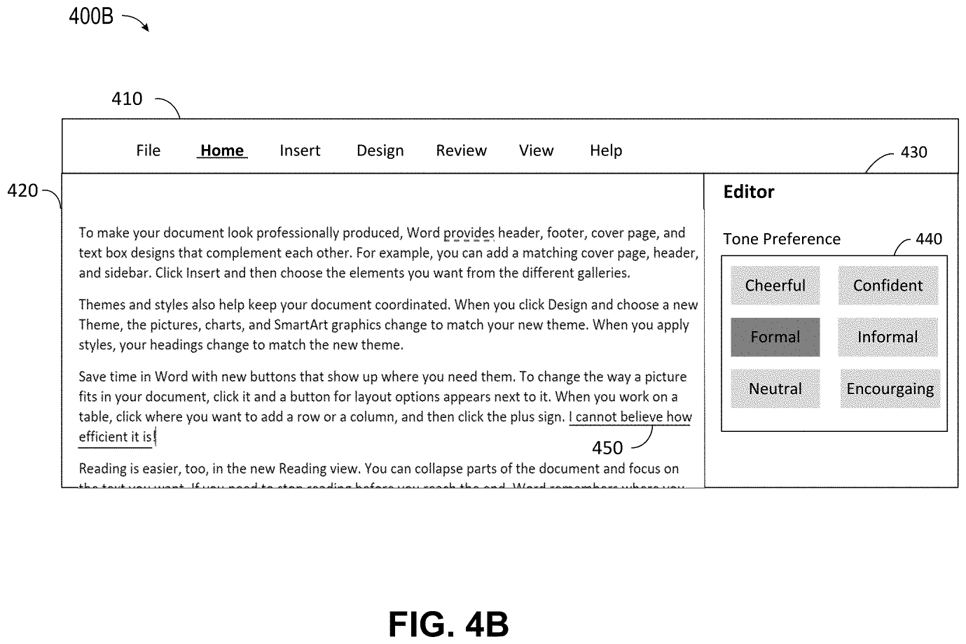

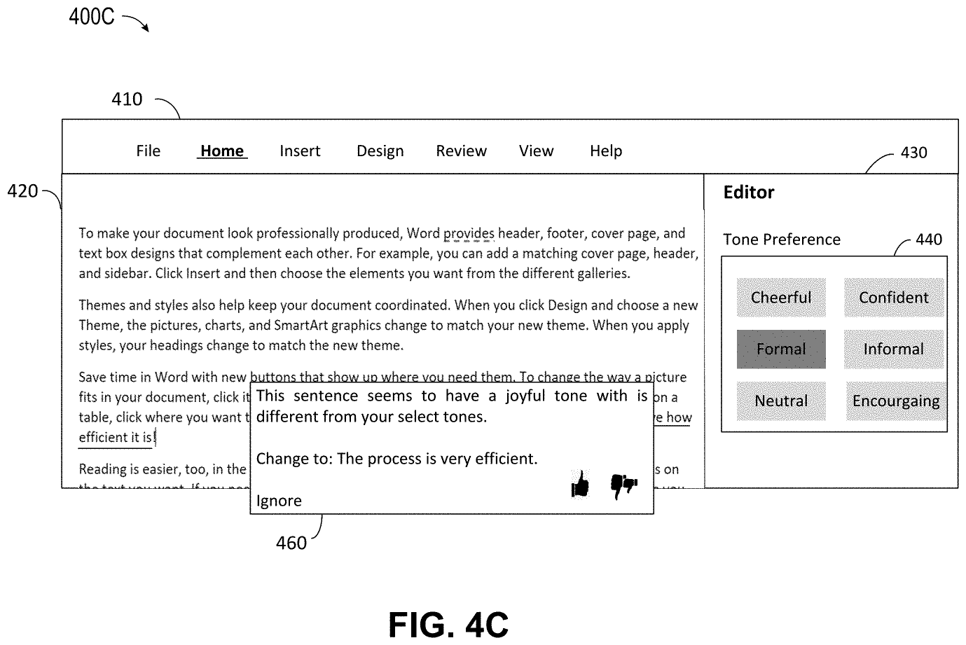

FIGS. 4A-4C are example GUI screens for allowing the user to choose one or more tones for a document. FIG. 4A is an example GUI screen 400A of a word processing application (e.g., Microsoft Word®) displaying an example document. GUI screen 400A may include a toolbar menu 410 containing various tabs each of which may provide multiple UI elements for performing various tasks. For example, the toolbar menu 410 may provide options for the user to perform one or more tasks to create or edit the document. Screen 400A may also contain a content pane 420 for displaying the content of the document. The screen 400A may also include an editor pane 430 for providing editing options such as selection of a tone. As such, the editor pane 430 may include a tone selection UI element 440 for choosing one or more tones for the document. The UI element 440 may include options for selecting the formality level of the document. The formality level may include informal, neutral, and formal. By selecting one of the provided formality levels, the user can choose the level of formality desired for the document. Furthermore, the user can choose one or more other tones for the document from a list of tones provided. For example, the provided tones may include confident or cheerful. Other tones such as the ones discussed above with respect to FIGS. 1A-1C may also be included. Thus, the user may choose to select a level of formality and/or other desired tones for the document. This may be achieved by clicking on each tone in the tone selection UI element 440.

Once the user chooses his/her selected tones for the document, the application may perform tone detection on the content of the document to determine if the content convey the tone(s) selected by the user. In some implementations, this may involve parsing the content into one or more text segment and examining each segment to detect its tone. When a tone that is different from or in conflict with the selected tones is identified, a notification may be provided to the user. In some implementations, this may be achieved by underlying the text segment that conveys the different tone. This is depicted in screen 400B of FIG. 4B where the text segment 450 is underlined. Alternatively and/or additionally, the text segment may be highlighted. Other known mechanisms may also be provided for notifying the user of the discrepant tone segment. In the example provided in screen 400B, the text segment 450 conveys a tone that is different from the formal and neutral tones selected by the user. As a result, the text segment 450 is underlined to notify the user of the discrepancy.

In some implementations, hovering over and/or clicking on the text segment 450 may cause a UI element such as UI element 460 of FIG. 4C to be displayed. The UI element 460 of screen 400C may include an indication that notifies the user of the detected tone of the segment and its discrepancy with the selected tone. Furthermore, the UI element 460 may include one or more suggested rephrases for rephrasing the segment such that it conveys the selected tones. Furthermore, as discussed above with respect to FIG. 2B, the UI element 460 may include one or more UI elements for receiving user feedback regarding the detected tone and/or the suggested rephrase.

It should be noted that the applications providing tone detection and/or modification functionalities may collect information from the document and/or the user as the user interacts with the detected tones and/or rephrase suggestions to better train the ML models used in providing tone detection and modification. For example, the application may collect information relating to which one of the suggested replacement text segments was selected by the user. To ensure that context is taken into account, when using the information, the sentence structure and style may also be collected. Additionally, other information about the document and/or the user may be collected. For example, information about the type of document (e.g., word document, email, presentation document, etc.), the topic of the document, the position of the user within an organization (e.g., the user's job title or department to which the user belongs, if known), and other non-linguistic features such as the time of the day, the date, the device used, the person to whom the document is directed (e.g., the to line in an email), and the like may be collected and used to provide better suggestions. The user specific information may be used, in one implementation, to provide customized suggestions for the user. For example, if it is determined that the user uses specific language when writing to a particular person, this information may be used to provide suggested rephrases the next time the user requests a suggestion when writing to the same person. It should be noted that in collecting and storing this information, care must be taken to ensure privacy is persevered, as discussed in more detail below.

Furthermore, to ensure compliance with ethical and privacy guidelines and regulations, in one implementation, an optional UI element may be provided to inform the user of the types of data collected, the purposes for which the data may be used and/or to allow the user to prevent the collection and storage of user related data. The UI may be accessible as part of features provided for customizing an application via a GUI displayed by the application when the user selects an options menu button. Alternatively, the information may be presented in a user agreement presented to the user when he/she first installs the application.

It should also be noted that although the current disclosure discusses written contents, the same methods and systems can be utilized to provide paraphrases for spoken words. For example, the methods discussed herein can be incorporated into or used with speech recognition algorithms to provide for tone detection and modification of a spoken phrase. For example, when a speech recognition mechanism is used to convert spoken words to written words, the user may request tone detection and modification for a spoken phrase. The spoken phrase may then be converted to a text segment before the text segment is examined and processed to provide tone detection and modification. The detected tone and/or suggested rephrase may then be spoken to the user.

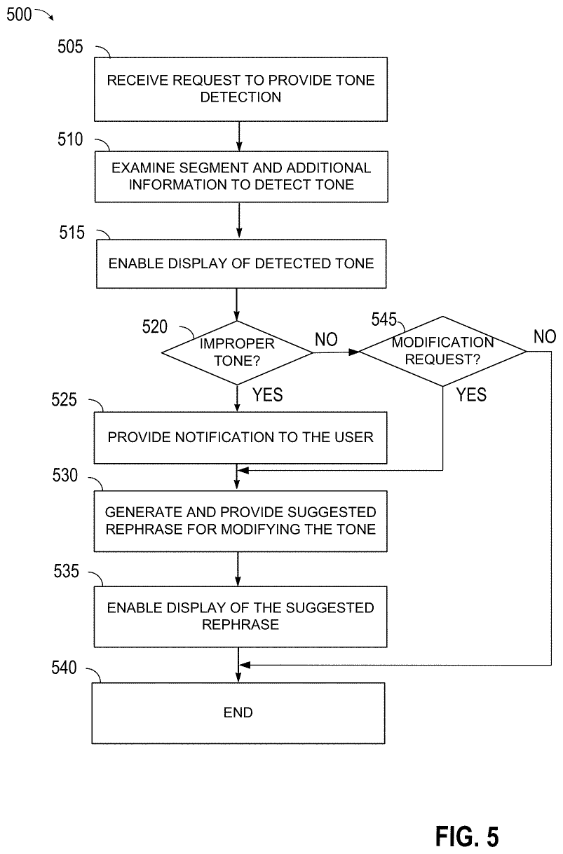

FIG. 5 is a flow diagram depicting an exemplary method 500 for providing intelligent tone detection and/or modification for a selected text segment. At 505, method 500 may begin by receiving a request to provide tone detection for a given text segment. This may occur, for example, when the user utilizes an input/output device (e.g. a mouse) coupled to a computer client device to a select a text segment (e.g., a text string containing one or more words, icons, emoticons and the like) in a document displayed by the client device and proceeds to invoke a UI element to request that tone detection be provided for the selected text segment. In one implementation, a request may be received when a predetermined action takes place within the content pane (e.g., a special character is entered, or a predetermined keyboard shortcut is pressed) after a phrase within the contents has been selected. In some implementation, the request for tone detection may be issued from an application such as applications 112/126 without user action. For example, the application may determine that content should be checked for tone because of the nature of the content being created (e.g., an important email). In such a case, the selected text segment may be the entire content or the text segment that the user recently finished creating (e.g., the latest sentence written).

Once a request to provide tone detection has been received, method 500 may proceed to examine the selected text segment along with other related information to detect the tone of the selected text segment, at 510. This may be done by a tone detection service such as the tone detection service 114 or local tone detection service 124 of FIGS. 1A-1C and may involve various steps discussed above with respect to FIGS. 1A-1C. For example, method 500 may first determine if the length of the selected text segment is appropriate for providing tone detection and if the selected text segment is too long, may employ a parsing engine to parse the segment into smaller segments for tone detection. In an implementation, an appropriate size for the selected text segment may be one sentence. Examining the selected text segment may also include determining if the selected text segment includes an identifiable word. This may include determining if the selected text segment includes words, numbers, and/or emoticons. For example, if the selected text segment consists of merely symbols (e.g., an equation), an error message may be provided indicating that the selected text segment is not appropriate for providing tone detection. If the request for tone detection originated from the application (e.g., the user did not request the tone detection), the selected text segment may simply be skipped.

In an implementation, the process of examining the selected text segment may first include receiving the selected text segment from the application. The process may also include retrieving and examining additional information about the user and/or the content. This may be done by utilizing one or more text analytics algorithms that may examine the contents, context, formatting and/or other parameters of the document to identify the structure of the sentence containing the selected text segment, a style associated with the paragraph and/or the document, keywords associated with the document (e.g. the title of the document), the type of content, the type of application, and the like.

The text analytics algorithms may include natural language processing algorithms that allow topic or keyword extractions, for example, in the areas of text classification and topic modeling. Examples of such algorithms include, but are not limited to, term frequency-inverse document frequency (TF-IDF) algorithms and latent Dirichlet allocation (LDA) algorithms. Topic modeling algorithms may examine the document to identify and extract salient words and items within the document that may be recognized as keywords. Keywords may then assist in determining the tone of the content.

The additional information may be provided to one or more ML models for detecting the tone of the selected segment. Once one or more tones are detected, method 500 may proceed to enable display of the detected tones, at 515. This may involve transmitting the detected tone(s) to the application for display. In some implementations, not all detected tones are provided for display. For example, where the request for tone detection is received from the application and not the user, only improper tones may be displayed. To perform this, method 500 may proceed to determine, at 520, whether one or more of the detected tone(s) is an improper tone. This may involve examining a predetermined list of improper tones which may vary depending on the type of content and/or application. Furthermore, the process of determining whether a detected tone is proper may include retrieving and examining additional information.

The additional information that may be collected and examined may include non-linguistic features of the document, the application and/or the user. For example, for a document that is being prepared for being sent to a recipient, (e.g., an email, letter or instant message), the person to whom the document is being directed may determine the proper tone and style of the document. In an example, an email being sent to a person's manager may need to contain formal language, as opposed to an email that is being sent to a family member. Thus, the information contained in the to line of the email may affect the proper tone of the contents and as such may be taken into account in determining whether a detected tone is proper, as discussed below and in how to provide replacement text segments for the selected text segment. In another example, the time of the day an email is being sent or the day of the week may assist in determining the proper tone of the content. For example, emails being sent on the weekend or late at night may be personal emails (e.g., informal), while those sent during the business hours may be work-related emails. Other non-linguistic features that may be taken into account include the type of document attached to an email, or the types of pictures, tables, charts, icons or the like included in the content of a document. Many other types of characteristics about the document or the user may be collected, transmitted (e.g., when a rephrasing service is being used), and examined in determining the proper tone for the content and in modifying the tone of the text segment.

In one implementation, machine learning algorithms may be used to examine activity history of the user within the document or within the user's use of the application to identify patterns in the user's usage. For example, the types of rephrase suggestions accepted by the user in a previous session of the document (or earlier in the current session) may be examined to identify patterns. In another example, detected improper tones that are ignored by the user may be collected and examined to determine if the user disregards certain tones. Furthermore, user history data may be collected and examined in providing suggested rephrases. This may be done during a prioritization and sorting process of identified suggestions. The history may be limited to the user's recent history (i.e., during a specific recent time period or during the current session) or may be for the entirety of the user's use of one or more applications. This information may be stored locally and/or in the cloud. In one implementation, the history data may be stored locally temporarily and then transmitted in batches to a data store in the cloud which may store each user's data separately for an extended period of time or as long as the user continues using the application(s) or as long as the user has granted permission for such storage and use.

In one implementation, replacement text segment suggestion history and data extracted from other users determined to be in a same category as the current user (e.g., in the same department, having the same job title, or being part of the same organization) may also being examined in determining tone appropriateness and/or providing rephrasing suggestions. Furthermore, method 500 may consult a global database of tone detection and/or rephrasing history and document contents to identify global patterns. In one implementation, in consulting the global database, the method identifies and uses data for users that are in a similar category as the current user. For example, the method may use history data from users with similar activities, similar work functions and/or similar work products. The database consulted may be global but also local to the current device.

When it is determined, at 520, that one or more of the detected tones are improper (Yes), method 500 may proceed to provide a notification to the user, at 525. This may involve transmitting an indication to the application which may in turn display a notification to the user (e.g., may highlight or underline the selected text). When it is determined, however, at 520, that the detected tone(s) are not improper, method 500 may proceed to determine, at 545, whether a request for modification of the tone has been received. In some implementations, the request may be initiated by the user after learning of a detected tone. For example, once the application notifies the user that the tone is formal, the user may decide that a preferred tone for the content is informal and as such may transmit a request via a UI element for modifying the tone to the desired tone. When it is determined, at step 545, that no modification request has been received, method 500 may proceed to step 540 to end.

When, however, it is determined, at 545, that a request for modification has been received or after providing the notification of improper tone to the user, at 525, method 500 may proceed to generate and provide suggested rephrases for modifying the tone, at 530. In one implementation, generating suggested rephrases may be achieved by utilizing two or more different types of trained ML models. One type could be a personal model which is trained based on each user's personal information and another could be a global model that is trained based on examination of a global set of other users' information. A hybrid model may be used to examine users similar to the current user and to generate results based on activities of other users having similar characteristics (same organization, having same or similar job titles, creating similar types of documents, and the like) as the current user. For example, it may examine users that create similar artifacts as the current user or create documents having similar topics. As discussed above and further below, any of the models may collect and store what is suggested and record how the user interacts with the suggestions (e.g., which suggestions they approve). This ensures that every time a user interacts with the system, the models learn from the interaction to make the suggestions better. The different models may be made aware of each other, so that they each benefit from what the other models are identifying, while focusing on a specific aspect of the task.

In one implementation, one or more of the models are created by first utilizing machine translation technology to generate a large text segment table (e.g., phrase table), and then using deep neural network techniques to generate the ML models that determine which rewrite alternatives are best in the context. This may be done by first using pre-neural machine translated text segment tables from multiple languages (e.g., 20 languages). In one implementation, heuristic weights for the tables may be replaced with similarity scores, and updated filters may be applied to remove offensive and non-inclusive language, sensitive terms (e.g., China is not the same Taiwan), and/or any private information (e.g., named entities, personal names, etc.). Next, annotation techniques may be used to evaluate usefulness of each candidate replacement text segment for a given original text segment in the table. This process may involve human evaluation of the text segments (e.g., using human judges) and may include thousands of original text segments and hundreds of thousands of candidate replacement text segments. These evaluations may help improve the text segment tables to ensure more appropriate suggestions are provided. The annotations may then be used in ranking metrics to determine how well the model may rank more relevant phrases higher and less relevant phrases lower. Thus, a neural network may be utilized as a language model in order to contextually rank the replacement text segments provided by the text segment table. Ranking metrics may then be used to reweight for scores provided by the text segment table and the language model.

In one implementation, direct phrase embeddings may also be used to learn a representation of textual segments directly to improve the quality of the models. In one approach, adaptive mixture of word representations may be used instead of averaging, and scores may be optimized on manually annotated textual similarity sets. In another approach, phrase skip-gram models may be trained to predict context words given a text segment. Additionally, representations of a text segment may be computed with neural models such as convolutional or recurrent neural networks.

In one implementation, the replacement text segments may be generated by a machine translation model that is a neural network. This may be in the form of a sequence-to-sequence mapping model, using a long short-term memory model, a transformer model, or any other neural model that is appropriate to the task. The training data may be compiled from naturally-occurring paraphrases, hand-authored rewrites for tone, before and after editing data, paraphrases generated by round-tripping translations, and any other means of synthesizing texts in which semantic equivalence is preserved. Training data may be selected for tone. The neural model may use various forms of multi-task and transfer learning from non-parallel data to achieve the desired characteristics of the rephrased text.

Referring back to FIG. 5, one or more of these models may be used to generate one or more rephrase suggestions for a given text segment, before method 500 enables display of the identified suggestions, at 535. Enabling the display may include transmitting the identified suggestions to the local application running on the user's client device which may utilize one or more UI elements such as those discussed above to display the rephrase suggesttions on a display device associated with the client device. The format in which the suggestions are displayed may vary. However, in most cases, the suggestions may be displayed alongside the contents to enable easy reference to the contents. Once the suggestions are displayed, method 500 may proceed to end at 540.

Because contextual information (e.g., surrounding words) and user specific information may need to be collected in order to provide a context for learning and since this information and all other linguistic features may contain sensitive and private information, compliance with privacy and ethical guidelines and regulations is important. Thus, the collection and storage of user feedback may need to be protected against both maleficent attackers who might expose private data and accidental leakage by suggestions made to other users having learned from the data. As such, during the process of collecting and transmitting feedback information, the information may be anonymized and encrypted, such that any user-specific information is removed or encrypted to ensure privacy.

In one implementation, where user-specific information is used to provide customized rephrasing suggestions, any private user-specific information may be stored locally. In another example, information about users within an organization may be stored with the network of the organization. In such instances, information relating to institutional users may be collected and stored in compliance with the organization's own policies and standards to permit the development of organizational learning models. However, even within organizational networks, privacy may often need to be maintained to prevent unauthorized leakage of organizational secrets within the organization.

Other steps may be taken to ensure that the information collected does not contain sensitive or confidential personal or organizational information. This is particularly important since information gathered from a document may be used to provide suggestions for global users and as such it is possible that a person's or organization's internal trade secrets or other highly sensitive information may be inadvertently leaked. In one implementation, the results of user feedback may be compared against a very large language model (e.g., a neural embedding model) and the information may be stored as an encrypted embedding along with frequency information. The learned model may then be updated periodically with this stored information to improve learning. In an example, differential privacy techniques may be utilized to ensure compliance with privacy. In another example, homomorphic encryption may be used. Other approaches may involve use of horizontal federated learning, vertical federated learning, or federated transfer learning which allow different degrees of crossover among domains without leakage.

Thus, methods and systems for providing intelligent tone detection and modification for a selected text segment are disclosed. The methods may utilize one or more machine-trained models developed for detecting and modify tone for a given text segment based on multiple factors including the context of a given text segment. The suggestions may then be displayed on the same UI screen as the document contents to enable the user to quickly and efficiently identify improper tone and/or approve the most appropriate suggested rephrased text segment. This provides an easy and efficient technical solution for enabling users to quickly determine the tone of content and modify an undesired or improper tone. This can improve the user's overall experience and increase their efficiency and proficiency when writing and/or speaking.

FIG. 6 is a block diagram 600 illustrating an example software architecture 602, various portions of which may be used in conjunction with various hardware architectures herein described, which may implement any of the above-described features. FIG. 6 is a non-limiting example of a software architecture and it will be appreciated that many other architectures may be implemented to facilitate the functionality described herein. The software architecture 602 may execute on hardware such as client devices, native application provider, web servers, server clusters, external services, and other servers. A representative hardware layer 604 includes a processing unit 606 and associated executable instructions 608. The executable instructions 608 represent executable instructions of the software architecture 602, including implementation of the methods, modules and so forth described herein.

The hardware layer 604 also includes a memory/storage 610, which also includes the executable instructions 608 and accompanying data. The hardware layer 604 may also include other hardware modules 612. Instructions 608 held by processing unit 608 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks 618, applications 620, and a presentation layer 624. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks 618 may provide various graphic user interface (GUI) functions, high-level resource management, or high-level location services. The frameworks 618 may provide a broad spectrum of other APIs for applications 620 and/or other software modules.

The applications 620 include built-in applications 620 and/or third-party applications 622. Examples of built-in applications 620 may include, but are not limited to, a contacts application, a browser application, a location application, a media application, a messaging application, and/or a game application. Third-party applications 622 may include any applications developed by an entity other than the vendor of the particular system. The applications 620 may use functions available via OS 614, libraries 616, frameworks 618, and presentation layer 624 to create user interfaces to interact with users.

Some software architectures use virtual machines, as illustrated by a virtual machine 628. The virtual machine 628 provides an execution environment where applications/modules can execute as if they were executing on a hardware machine (such as the machine 600 of FIG. 6, for example). The virtual machine 628 may be hosted by a host OS (for example, OS 614) or hypervisor, and may have a virtual machine monitor 626 which manages operation of the virtual machine 628 and interoperation with the host operating system. A software architecture, which may be different from software architecture 602 outside of the virtual machine, executes within the virtual machine 628 such as an OS 650, libraries 652, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement methods or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multi-core processor including cores that may execute instructions contemporaneously. Although FIG. 7 shows multiple processors, the machine 700 may include a single processor with a single core, a single processor with multiple cores (for example, a multi-core processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion. The term “machine-readable medium,” as used herein, does not encompass transitory electrical or electromagnetic signals per se (such as on a carrier wave propagating through a medium); the term “machine-readable medium” may therefore be considered tangible and non-transitory. Non-limiting examples of a non-transitory, tangible machine-readable medium may include, but are not limited to, nonvolatile memory (such as flash memory or read-only memory (ROM)), volatile memory (such as a static random-access memory (RAM) or a dynamic RAM), buffer memory, cache memory, optical storage media, magnetic storage media and devices, network-accessible or cloud storage, other types of storage, and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756 and/or position components 762, among a wide array of other environmental sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, and/or facial-based identification). The position components 762 may include, for example, location sensors (for example, a Global Position System (GPS) receiver), altitude sensors (for example, an air pressure sensor from which altitude may be derived), and/or orientation sensors (for example, magnetometers).

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 762, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIGS. 1-5) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

In the following, further features, characteristics and advantages of the invention will be described by means of items:

Item 1. A data processing system comprising:
a processor; and
a memory in communication with the processor, the memory comprising executable instructions that, when executed by, the processor, cause the data processing system to perform functions of:
   receiving a request to detect a tone for a content segment;
   inputting the content segment into a first machine-learning (ML) model to detect the tone for the content segment;
   obtaining the detected tone as a first output from the first ML model;
   inputting the content segment into a second ML model for modifying the tone from the detected tone to a modified tone;
   obtaining at least one rephrased content segment as a second output from the second ML model, the rephrased content segment modifying the tone of the content segment from the detected tone to the modified tone; and
   providing at least one of the detected tone or the at least one rephrased content segment for display.
      Item 2. The data processing system of item 1, wherein the instructions further cause the processor to cause the data processing system to perform functions of:
receiving an input indicating a user's selection of the rephrased content segment; and
upon receiving the input, replacing the content segment with the rephrased content segment.
   Item 3. The data processing system of item 2, wherein the instructions further cause the processor to cause the data processing system to perform functions of:
collecting user feedback information relating to the user's selection of the rephrased content segment;
ensuring that the user feedback information is privacy compliant; and
storing the user feedback information for use in improving at least one of the first ML model or the second ML model.
   Item 4. The data processing system of any one of the preceding items, wherein providing the at least one of the detected tone or the at least one rephrased content segment for display includes displaying the at least one of the detected tone or the at least one rephrased content segment on a user interface element.
   Item 5. The data processing system of any one of the preceding items, wherein the instructions further cause the processor to cause the data processing system to perform functions of:
determining if the detected tone conveys an improper tone; and
upon determining that the detected tone conveys an improper tone, providing a notification of the improper tone for display.
   Item 6. The data processing system of item 5, wherein the instructions further cause the processor to cause the data processing system to perform functions of:
identifying a proper tone for the content segment;
upon identifying the proper tone, generating a properly toned rephrased content segment, the properly toned rephrased content segment conveying the proper tone for the content segment; and
providing the properly toned content segment as a suggested rephrase for display.
   Item 7. The data processing system of item 6, wherein determining if the detected tone conveys an improper tone includes examining at least one of a type of the content segment, an application from which the content segment originates, user history data, contextual information about a document from which the content segment originates, and a person to which the content segment is directed.
   Item 8. A method for providing tone detection for a content segment, comprising:
receiving a request to detect a tone for the content segment;
inputting the content segment into a first machine-learning (ML) model to detect the tone for the content segment;
obtaining the detected tone as a first output from the first ML model;
inputting the content segment into a second ML model for modifying the tone from the detected tone to a modified tone;
obtaining at least one rephrased content segment as a second output from the second ML model, the rephrased content segment modifying the tone of the content segment from the detected tone to the modified tone; and
providing at least one of the detected tone or the at least one rephrased content segment for display.
   Item 9. The method of item 8, further comprising:
receiving an input indicating a user's selection of the rephrased content segment; and
upon receiving the input, replacing the content segment with the rephrased content segment.
   Item 10. The method of item 9, further comprising:
collecting user feedback information relating to the user's selection of the rephrased content segment;
ensuring that the user feedback information is privacy compliant; and
storing the user feedback information for use in improving at least one of the first ML model or the second ML model.
   Item 11. The method of any of items 8-10, wherein providing the at least one of the detected tone or the at least one rephrased content segment for display includes displaying the at least one of the detected tone or the at least one rephrased content segment on a user interface element.
   Item 12. The method of any of items 8-11, further comprising:
determining if the detected tone conveys an improper tone; and
upon determining that the detected tone conveys an improper tone, providing a notification of the improper tone for display.
   Item 13. The method of item 12, further comprising:
identifying a proper tone for the content segment;
upon identifying the proper tone, generating a properly toned rephrased content segment, the properly toned rephrased content segment conveying the proper tone for the content segment; and
providing the properly toned content segment as a suggested rephrase for display.
   Item 14. The method of item 13, wherein determining if the detected tone conveys an improper tone includes examining at least one of a type of the content segment, an application from which the content segment originates, user history data, contextual information about a document from which the content segment originates, and a person to which the content segment is directed.
   Item 15. A non-transitory computer readable medium on which are stored instructions that, when executed, cause a programmable device to:
receive a request to detect a tone for a content segment;
input the content segment into a first machine-learning (ML) model to detect the tone for the content segment;
obtain the detected tone as a first output from the first ML model; input the content segment into a second ML model for modifying the tone from the detected tone to a modified tone;
obtain at least one rephrased content segment as a second output from the second ML model, the rephrased content segment modifying the tone of the content segment from the detected tone to the modified tone; and
provide at least one of the detected tone or the at least one rephrased content segment for display.
   Item 16. The non-transitory computer readable medium of item 15, wherein the instructions further cause the programmable device to:
receiving an input indicating a user's selection of the rephrased content segment; and upon receiving the input, replacing the content segment with the rephrased content segment.
   Item 17. The non-transitory computer readable medium of item 16, wherein the instructions further cause the programmable device to:
collecting user feedback information relating to the user's selection of the rephrased content segment;
ensuring that the user feedback information is privacy compliant; and
storing the user feedback information for use in improving at least one of the first ML model or the second ML model.
   Item 18. The non-transitory computer readable medium of any of items 15-17, wherein providing the at least one of the detected tone or the at least one rephrased content segment for display includes displaying the providing the at least one of the detected tone or the at least one rephrased content segment on a user interface element.
   Item 19. The non-transitory computer readable medium of any of items 15-18, further comprising:
determining if the detected tone conveys an improper tone; and
upon determining that the detected tone conveys an improper tone, providing a notification of the improper tone for display.
   Item 20. The non-transitory computer readable medium of any of items 15-19, wherein determining if the detected tone conveys an improper tone includes examining at least one of a type of the content segment, an application from which the content segment originates, user history data, contextual information about a document from which the content segment originates, and a person to which the content segment is directed.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

The Abstract of the Disclosure is provided to allow the reader to quickly identify the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that any claim requires more features than the claim expressly recites. Rather, as the following claims reflect, inventive subject matter lies in less than all features of a single disclosed example. Thus, the following claims are hereby incorporated into the Detailed Description, with each claim standing on its own as a separately claimed subject matter.

1. A data processing system comprising:
a processor; and
a memory in communication with the processor, the memory comprising executable instructions that, when executed by the processor, cause the data processing system to perform functions of:
receiving a request to detect a tone for a content segment;
inputting the content segment into a first machine-learning (ML) model to detect the tone for the content segment;
obtaining the detected tone as a first output from the first ML model;
automatically analyzing the detected tone to determine that the detected tone conveys an improper tone;
in response to determining that the detected tone conveys an improper tone, providing a notification for display, the notification displaying a description of the detected tone and indicating that the detected tone conveys an improper tone;
inputting the content segment into a second ML model for modifying the tone from the detected tone to a modified tone;
obtaining at least one rephrased content segment as a second output from the second ML model, the rephrased content segment modifying the tone of the content segment from the detected tone to the modified tone; and
providing the at least one rephrased content segment for display.

2. The data processing system of claim 1, wherein the instructions further cause the processor to cause the data processing system to perform functions of:
receiving an input indicating a user's selection of the rephrased content segment; and
upon receiving the input, replacing the content segment with the rephrased content segment.

3. The data processing system of claim 2, wherein the instructions when executed by the processor further cause the data processing system to perform functions of:
collecting user feedback information relating to the user's selection of the rephrased content segment;
ensuring that the user feedback information is privacy compliant; and
storing the user feedback information for use in improving at least one of the first ML model or the second ML model.

4. The data processing system of claim 1, wherein providing the at least one rephrased content segment for display includes displaying the at least one rephrased content segment on a user interface element.

5. (canceled)

6. The data processing system of claim 1, wherein the instructions when executed by the processor, further cause the data processing system to perform functions of:
identifying a proper tone for the content segment;
upon identifying the proper tone, generating a properly toned rephrased content segment, the properly toned rephrased content segment conveying the proper tone for the content segment; and
providing the properly toned content segment as a suggested rephrase for display.

7. The data processing system of claim 1, wherein determining that the detected tone conveys an improper tone includes examining at least one of a type of the content segment, an application from which the content segment originates, user history data, contextual information about a document from which the content segment originates, and a person to which the content segment is directed.

8. A method for providing tone detection for a content segment, comprising:
receiving a request to detect a tone for the content segment;
inputting the content segment into a first machine-learning (ML) model to detect the tone for the content segment;
obtaining the detected tone as a first output from the first ML model;
automatically analyzing the detected tone to determine that the detected tone conveys an improper tone;
in response to determining that the detected tone conveys an improper tone, providing a notification for display, the notification displaying a description of the detected tone and indicating that the detected tone conveys an improper tone;
inputting the content segment into a second ML model for modifying the tone from the detected tone to a modified tone;
obtaining at least one rephrased content segment as a second output from the second ML model, the rephrased content segment modifying the tone of the content segment from the detected tone to the modified tone; and
providing the at least one rephrased content segment for display.

9. The method of claim 8, further comprising:
receiving an input indicating a user's selection of the rephrased content segment; and
upon receiving the input, replacing the content segment with the rephrased content segment.

10. The method of claim 9, further comprising:
collecting user feedback information relating to the user's selection of the rephrased content segment;
ensuring that the user feedback information is privacy compliant; and
storing the user feedback information for use in improving at least one of the first ML model or the second ML model.

11. The method of claim 8, wherein providing the at least one rephrased content segment for display includes displaying the at least one rephrased content segment on a user interface element.

12. (canceled)

13. The method of claim 8, further comprising:
identifying a proper tone for the content segment;
upon identifying the proper tone, generating a properly toned rephrased content segment, the properly toned rephrased content segment conveying the proper tone for the content segment; and
providing the properly toned content segment as a suggested rephrase for display.

14. The method of claim 8, wherein determining if the detected tone conveys an improper tone includes examining at least one of a type of the content segment, an application from which the content segment originates, user history data, contextual information about a document from which the content segment originates, and a person to which the content segment is directed.

15. A non-transitory computer readable medium on which are stored instructions that, when executed, cause a programmable device to:
receive a request to detect a tone for a content segment;
input the content segment into a first machine-learning (ML) model to detect the tone for the content segment;
obtain the detected tone as a first output from the first ML model;
automatically analyze the detected tone to determine that the detected tone conveys an improper tone;
in response to determining that the detected tone conveys an improper tone, provide a notification for display, the notification displaying a description of the detected tone and indicating that the detected tone conveys an improper tone;
input the content segment into a second ML model for modifying the tone from the detected tone to a modified tone;
obtain at least one rephrased content segment as a second output from the second ML model, the rephrased content segment modifying the tone of the content segment from the detected tone to the modified tone; and
provide the at least one rephrased content segment for display.

16. The non-transitory computer readable medium of claim 15, wherein the instructions further cause the programmable device to:
receive an input indicating a user's selection of the rephrased content segment; and
upon receiving the input, replace the content segment with the rephrased content segment.

17. The non-transitory computer readable medium of claim 16, wherein the instructions further cause the programmable device to:
collect user feedback information relating to the user's selection of the rephrased content segment;
ensure that the user feedback information is privacy compliant; and
store the user feedback information for use in improving at least one of the first ML model or the second ML model.

18. The non-transitory computer readable medium of claim 15, wherein providing the at least one rephrased content segment for display includes displaying the at least one rephrased content segment on a user interface element.

19. (canceled)

20. The non-transitory computer readable medium of claim 15, wherein determining if the detected tone conveys an improper tone includes examining at least one of a type of the content segment, an application from which the content segment originates, user history data, contextual information about a document from which the content segment originates, and a person to which the content segment is directed.

21. The data processing system of claim 1, wherein the instructions when executed by the processor further cause the data processing system to perform functions of providing for display a user interface element for receiving user feedback regarding accuracy of the detected tone.
